(19) United States
(12) Patent Application Publication
(10) Pub. No.: US 2006/0215197 A1
(43) Pub. Date: Sep. 28, 2006

(54) Print image display device, print image display method, and print image display program

(75) Inventor: Masato Tobioka, Kanagawa (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 11/187,026

(22) Filed: Jul. 22, 2005

(30) Foreign Application Priority Data
Mar. 24, 2005 (JP) 2005-086616

(51) Int. Cl. G06F 3/12

(52) U.S. Cl. 358/1.13; 358/527

(57) ABSTRACT

A print image display device includes an event detection unit that detects an occurrence of an event in an UI for setting a printing parameter; a preview image generating unit that generates, in response to the event, a plurality of print images the printing parameter of which is different from each other; a display that displays the plurality of print images for preview; and a print parameter setting unit that sets, upon selection of one of the print images, the printing parameter according to the selected print image.

### BACKGROUND OF THE INVENTION

1. Field of the Invention

The present invention relates to a print image display device, a print image display method, and a print image display program. In particular, the present invention relates to a print image display device, a print image display method, and a print image display program, which enable the display of a preview of a print image after formation of the image.

2. Description of the Related Art

It is generally performed, when printing out an image with the use of an image forming apparatus such as a printer or a multiple-function printer, to check the printing result of the image in advance by causing the apparatus to display a preview representing the print mage to be printed out.

In some cases, an image is printed out on a medium such as paper after being enlarged or reduced to a desired size. In such cases, a preview of the print image is displayed at a magnification designated by a user.

However, it is often a case that the user cannot obtain a preview result as he/she wants. In such case, the user is required to cause the preview of the print image to be displayed repeatedly while changing the scaling of the image to determine the magnification at which his/her desired print result can be obtained. This costs the user considerable labor and time.

### SUMMARY OF THE INVENTION

The present invention has been made in view of the above circumstances and provides a print image display device, a print image display method, and a print image display program, which make it possible to easily determine an image magnification at which a desired print result can be obtained.

According to an aspect of the present invention, a print image display device includes an event detection unit that detects an occurrence of an event in an UI for setting a printing parameter; a preview image generating unit that generates, in response to the event, plural print images the printing parameter of which is different from each other; a display that displays the plural print images for preview; and a print parameter setting unit that sets, upon selection of one of the print images, the printing parameter according to the selected print image.

### BRIEF DESCRIPTION OF THE DRAWINGS

Embodiments of the present invention will be described in detail based on the following figures, wherein:

FIG. 1 is a function block diagram showing configuration of a print image display device according to a preferred embodiment of the present invention;

FIG. 2 is a flowchart showing processing executed by the print image display device according to the preferred embodiment;

FIG. 3 shows an example of a printing option setup screen;

FIG. 4 shows an example of a printing option setup screen having a multiple preview field;

FIG. 5 shows another example of a printing option setup screen having a multiple preview field; and

FIG. 6 shows still another example of a printing option setup screen having a multiple preview field.

### DETAILED DESCRIPTION OF THE EMBODIMENTS

Embodiment of the present invention will now be described with reference to the attached drawings.

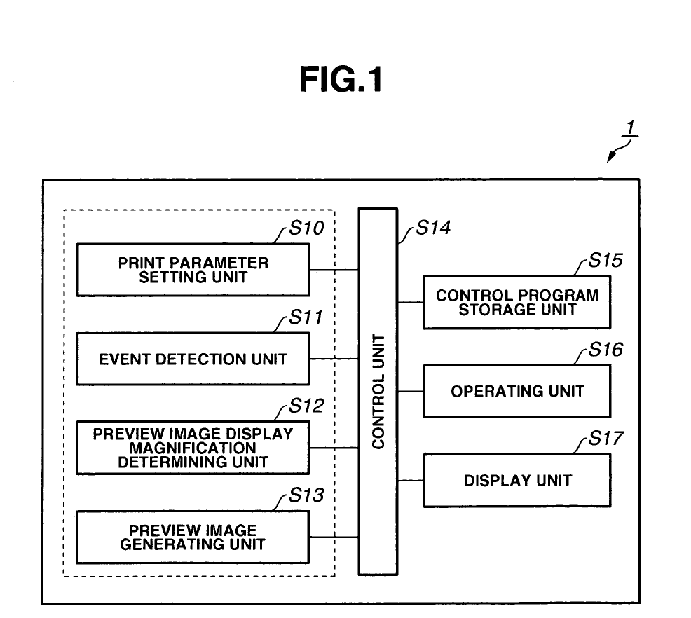

FIG. 1 is a function block diagram showing configuration of a print image display device according to the preferred embodiment of the present invention. As shown in FIG. 1, the print image display device 1 includes a print parameter setting unit 10, an event detection unit 1, a preview image display magnification determining unit 12, a preview image generating unit 13, a control unit 14, a control program storage unit 15, an operating unit 16, and a display 17.

The print parameter setting unit 10 displays a printing option setup screen which serves as an UI (user interface) for setting printing parameters, on the display 17. The print parameter setting unit 10 thus receives inputs of scaling parameters indicating an scaling ratio (magnification) of an image to be printed out and printing parameters such as a printing orientation and medium size required for printing out an image, and sets these parameters.

The event detection unit 11 detects an occurrence of an event when a cursor moves into an event detection area of the printing option setup screen.

The preview image display magnification determining unit 12 determines magnifications of preview images to be displayed simultaneously.

The preview image generating unit 13 generates preview images of the print image which is displayed for preview.

The control unit 14 executes processing for controlling the entire print image display device and parts and components thereof.

The control program storage unit 15 stores a control program for having the control unit 14 to control the entire print image display device and the parts and components thereof.

The operating unit 16 is an operational terminal (pointing device) such as a mouse.

The display 17 is a display terminal such as a visual display terminal.

In FIG. 1, the part enclosed by the broken line (containing the print parameter setting unit 10, the event detection unit 11, the preview image display magnification determining unit 12, and the preview image generating unit 13) is embodied by software or the like.

The print image display device having the configuration according to the embodiment above generates print images at plural magnifications to display previews of the print images.

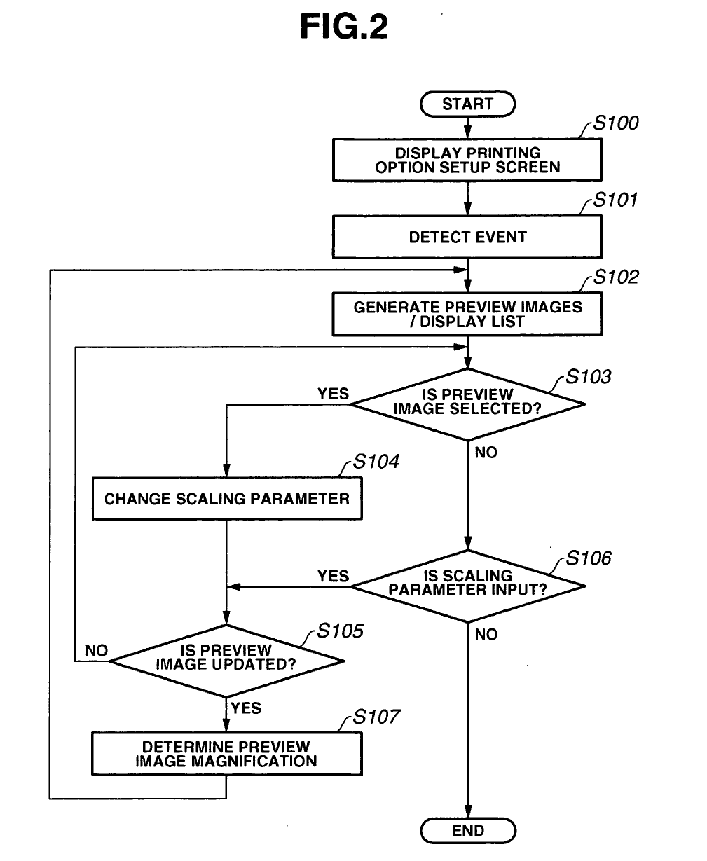

FIG. 2 is a flowchart showing the processing executed by the print image display device according to the present embodiment.

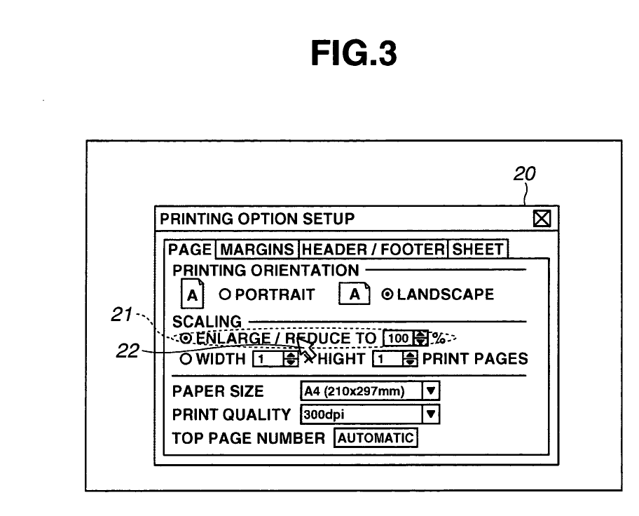

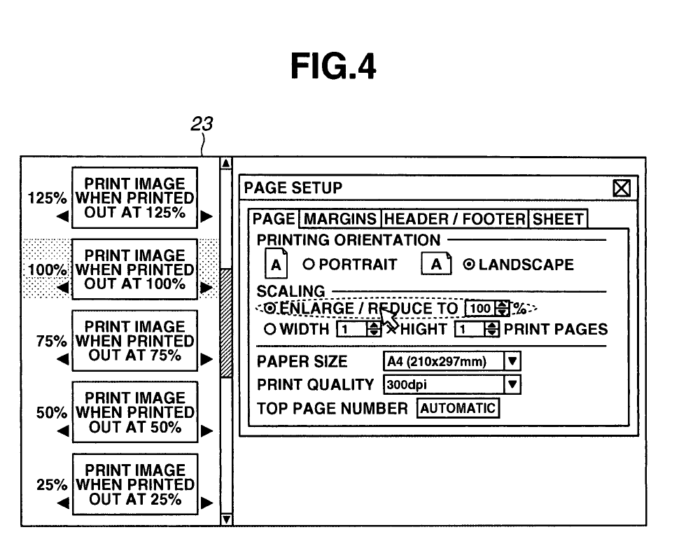

As shown in FIG. 3, a printing option setup screen 20 is displayed (step 100). If a cursor 22 is moved to an event detection area 21, the event is detected (step 101). A print image is generated for each of predetermined magnifications (representative options) and, as sown in FIG. 4, a list of the print images thus generated at the respective magnifications (125%, 100%, 75%, 50% and 25%, in FIG. 4) is displayed in a multiple preview field 23 (step 102).

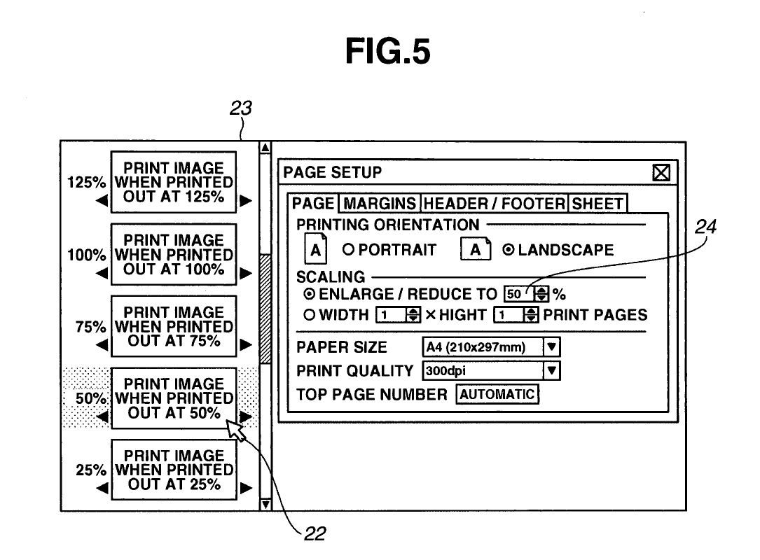

When, as shown in FIG. 5, one of the preview images is selected (the 50% image in FIG. 5) (YES in step 103), a scaling parameter 24 for setting the scaling ratio for the image to be printed out is changed to that of the selected preview image (step 104). It is then determined whether or not the preview images are to be updated based on the magnifications of the preview images currently displayed in the multiple preview field 23 (step 105).

If no preview image is selected (NO in step 103), and the printing option setup screen 20 is closed (no scaling parameter 24 is input) (NO in step 106), the processing is terminated. If the scaling parameter 24 is directly input (YES in step 106), it is determined whether or not the preview images are to be updated based on the magnifications of the preview images currently displayed (step 105).

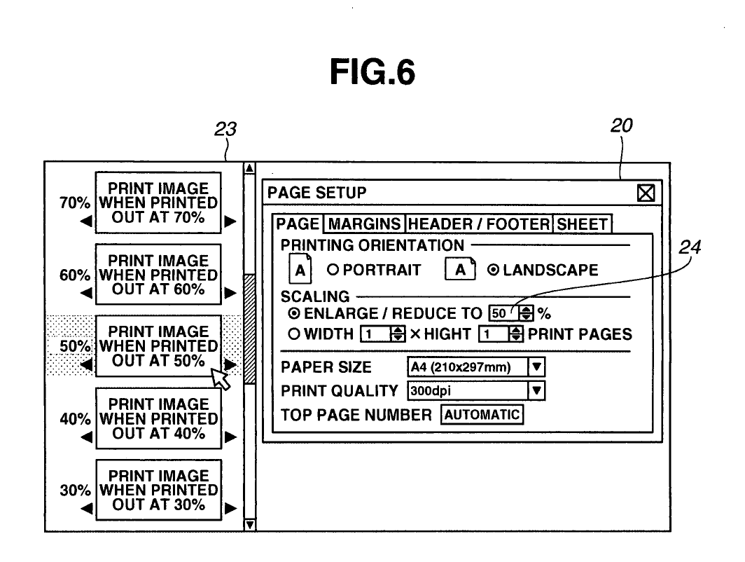

If it is determined, in step 105, that the preview images are to be updated (YES in step 105), magnifications for preview images to be newly displayed in the multiple preview field 23 are determined based on the magnifications of the preview images currently displayed and the magnification of the selected preview image (step 107). As shown in FIG. 6, print images at the respective magnifications (70%, 60%, 50%, 40% and 30% in FIG. 6) are displayed in the multiple preview field 23 to update the preview images (step 102).

In contrast, if it is determined, in step 105, that the preview images are not to be updated (NO in step 105), the preview images in the multiple preview field 23 are retained until one of the preview images is selected (step 103).

In the present embodiment, the magnifications of 125%, 100%, 75%, 50% and 25% are used as the representative options for displaying preview images in the first screen. However, the representative options are not limited to these magnifications, and any other magnifications may be used.

When the preview image magnifications are determined in step 107, if the Nth preview image is selected among the preview images, the interval between the magnifications for the (N+1)th preview image and the (N−1)the preview image is subdivided into a predetermined number of intervals to determine the magnifications of the preview images to be newly displayed.

The intervals of the printing parameters (the number of print images to be generated) may be determined based on the number of print images that can be displayed for preview.

Further, the magnifications of print images to be displayed when updating the preview images may be predetermined based on a selected magnification. For example, in the case when the magnification of 50% is selected, the print images may be displayed for preview at the magnifications of 40%, 45%, 50%, 55% and 60%, respectively. The magnifications of the preview print images to be displayed during the updating may be determined by any suitable method.

In the present embodiment, plural print images are displayed at different magnifications, which are one of the printing parameters. However, the printing parameter which is varied is not limited to magnification, and any other printing parameter may be used. For example, paper size or number of images displayed on a sheet of paper (e.g., 2UP, 3UP and the like) may be used. Further, an event detection area may be provided according to a printing parameter employed.

According to the present invention, as described above, plural print images are simultaneously displayed for preview at respective magnifications. This enables an user to set an appropriate scaling parameter more easily while comparing the plural print images thus displayed at different magnifications.

According to the present invention, when the Nth preview image is selected, the interval between the magnifications for the (N+1)th preview image and the (N−1)the preview image is subdivided into a predetermined number of intervals to determine the magnifications of the preview images to be newly displayed. This makes it possible to set a more accurate scaling parameter easily and reliably.

As described above, according to an aspect of the present invention, a print image display device includes an event detection unit that detects an occurrence of an event in an UI for setting a printing parameter; a preview image generating unit that generates, in response to the event, plural print images which represent different printing parameters; a display that displays the plural print images for preview; and a print parameter setting unit that sets, upon selection of one of the print images, the printing parameter according to the selected print image.

According to another aspect of the present invention, A print image display method includes detecting an occurrence of an event in an UI for setting a printing parameter; generating plural print images which represent different printing parameters in response to the event; displaying a preview of the plural print images; and setting the printing parameter according to the selected print image upon selection of one of the print images.

According to yet another aspect of the present invention, a print image display program causes a computer to execute event detection processing to detect an occurrence of an event in an UI for setting a printing parameter; preview image generation processing to generate, in response to the event, plural print images which represent different printing parameters; display processing to display the generated print images for preview; and printing parameter setting processing to set, upon selection of one of the print images, the printing parameter according to the selected print image.

According to even another aspect of the present invention, in the print image display program, the preview image generating processing further causes the computer to execute processing to generate, upon selection of one of the print images displayed for preview, print images to be newly displayed based on the printing parameter of the selected print image; and the display processing further causes the computer to execute processing to display the print images. An interval between the printing parameters of the print images to be newly displayed may be smaller than an interval between the printing parameters of the print images which are already displayed.

According to further aspect of the present invention, in the print image display program, the preview image generation processing further causes the computer to execute processing to determine printing parameters of print images to be generated, based on a number of print images which can be displayed for preview.

According to still further aspect of the present invention, in the print image display program, the preview image generation processing further causes the computer to execute processing to subdivide an interval from the printing parameter of the selected print image into smaller intervals to determine printing parameters of the print images to be generated.

The forgoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

The entire disclosure of Japanese Patent Application No. 2005-86616 filed on Mar. 24, 2005 including specification, claims, drawings and abstract is incorporated herein by reference in its entirety.

What is claimed is:

1. A print image display device comprising:
an event detection unit that detects an occurrence of an event in an UI for setting a printing parameter;
a preview image generating unit that generates, in response to the event, a plurality of print images which represents different printing parameters;
a display that displays the plurality of print images for preview; and
a print parameter setting unit that sets, upon selection of one of the print images, the printing parameter according to the selected print image.

2. A print image display method comprising:
detecting an occurrence of an event in an UI for setting a printing parameter;
generating a plurality of print images which represents different printing parameters in response to the event;
displaying the plurality of print images for preview; and
setting, upon selection of one of the print images, the printing parameter according to the selected print image.

3. A storage medium storing a program that causes a computer to execute a function comprising:
detecting an occurrence of an event in an UI for setting a printing parameter;
generating a plurality of print images which represents different printing parameters in response to the event;
displaying the plurality of print images for preview; and
setting, upon selection of one of the print images, the printing parameter according to the selected print image.

4. The storage medium according to claim 3, the function further comprising:
generating a plurality of print images to be newly displayed, printing parameters of which are based on the printing parameter of the selected print image; and
displaying the plurality of print images for preview.

5. The storage medium according to claim 3, wherein:
printing parameters of print images to be generated are based on a number of print images which can be displayed for preview.

6. The storage medium according to claim 4, wherein:
an interval between the printing parameters of the print images to be newly displayed is smaller than an interval between the printing parameters of the print images which are already displayed.

7. The storage medium according to claim 3, wherein:
the printing parameter which is represented by the print image is magnification.

8. The storage medium according to claim 3, wherein:
the printing parameter which is represented by the print image is paper size.

9. The storage medium according to claim 3, wherein:
the printing parameter which is represented by the print image is number of images displayed on a sheet of paper.

10. A print image display method according to claim 2, further comprising:
generating a plurality of print images to be newly displayed, printing parameters of which are based on the printing parameter of the selected print image; and
displaying the plurality of print images for preview.

11. A print image display method according to claim 2, wherein:
printing parameters of the plurality of print images to be generated are based on a number of print images which can be displayed for preview.

12. A print image display method according to claim 10, wherein: an interval between the printing parameters of the print images to be newly displayed is smaller than an interval between the printing parameters of the print images which are already displayed.

13. A print image display method according to claim 2, wherein:
the printing parameter which is represented by the print image is magnification.

14. A print image display method according to claim 2, wherein:
the printing parameter which is represented by the print image is paper size.

15. A print image display method according to claim 2, wherein:
the printing parameter which is represented by the print image is number of images displayed on a sheet of paper.

16. The print image display device according to claim 1, further comprising:
a preview image generating unit that generates a plurality of print images to be newly displayed, printing parameters of which are based on the printing parameter of the selected print image; and
a display that displays the plurality of print images for preview.

17. The print image display device according to claim 1, wherein:
printing parameters of the plurality of print images to be generated are based on a number of print images which can be displayed for preview.

18. The print image display device according to claim 16, wherein: an interval between the printing parameters of the print images to be newly displayed is smaller than an interval between the printing parameters of the print images which are already displayed.

19. The print image display device according to claim 1, wherein: the printing parameter which is represented by the print image is magnification.

20. The print image display device according to claim 1, wherein:
the printing parameter which is represented by the print image is paper size.
